(19) United States
(12) Patent Application Publication
(10) Pub. No.: US 2007/0213431 A1
(43) Pub. Date: Sep. 13, 2007

(54) COMPATIBILIZED THERMOPLASTIC ELASTOMER COMPOSITIONS

(75) Inventor: Ashok M. Adur, Westlake, OH (US)

Correspondence Address: POLYONE CORPORATION, 33587 WALKER ROAD, AVON LAKE, OH, 44012, US

(73) Assignee: PolyOne Corporation, Avon Lake, OH (US)

(21) Appl. No.: 11/570,413

(22) PCT Filed: Jun. 27, 2005
(86) PCT No.: PCT/US05/22824

§ 371 Date: Dec. 11, 2006

Related U.S. Application Data
(60) Provisional application No. 60/583,827, filed on Jun. 29, 2004.

(51) Int. Cl. C08L 83/04; C09B 67/00; C08L 23/06; C08L 23/10; C08L 51/04; C08L 51/06; C08L 51/08

(52) U.S. Cl. 524/63; 524/502; 524/588

(57) ABSTRACT

A thermoplastic elastomer is disclosed, comprising a polyolefin, a silicone rubber, and a compatibilizing agent comprising a silicone-containing polymer comprising both olefin- and silicone-containing moieties.

### CLAIM OF PRIORITY

This application claims priority from U.S. Provisional Patent Application Ser. No. 60/583,827 bearing Attorney Docket Number 12003011 and filed on Jun. 29, 2004.

### FIELD OF THE INVENTION

This invention relates to compatibilized thermoplastic elastomer compositions of polyolefins and silicone rubbers.

### BACKGROUND OF THE INVENTION

In the past several decades, the use of polymers has transformed the world. Polymer science has rapidly evolved to make thousands of different thermoplastic and thermosetting products within the four comers of polymer technology: thermoplastic plastics, thermoplastic elastomers, thermoset plastics, and thermoset elastomers.

No large scale production of any polymer can rest on current ingredients or processing conditions. Reduction of cost, improvement of productivity, delivery of better performing, and lower cost products all drive the polymer science industry. The situation is no different for thermoplastic elastomers (TPEs).

Since the emergent use of silicone rubber in the 1940s, the use of silicone rubber has grown significantly, even finding its way into TPE production. Largely, this is due to a variety of useful properties possessed by many silicone rubbers. These properties include their wide useful temperature range (often extending from about −65° C. to about 315° C.), their resistance to hydrocarbon chemicals, their flexibility, and their relative inertness to ozone, corona, and other extreme weather environments.

Despite those beneficial properties, silicone rubber is relatively expensive, limiting its practical usefulness in certain applications. Further, processing of silicone rubber often requires complicated thermoset processing equipment and its associated drawbacks.

Yet, due to its beneficial properties, TPE compositions made with silicone rubber are desirable. While it is known to formulate TPEs based on silicone rubber, all those commercially available are expensive. Hence, further and improved compositions and processes for preparation thereof are needed.

### SUMMARY OF THE INVENTION

What is needed in the art of thermoplastic elastomers (TPEs) is a relatively low cost, yet high performance, TPE made from polyolefins and silicone rubbers, especially a TPE that provides comparable or superior resistance to organic oils (e.g., naturally occurring oils, such as vegetable oils and animal fats, and other hydrocarbon oils), particularly at high temperatures especially at over 140° C.

It has not been previously known how to effectively obtain compatibilized compositions comprising both relatively low cost polyolefins and high performance silicone rubbers. Without sufficient compatibilization of the TPE components, certain performance properties of the TPE remain less than optimal. Had it been known previously how to compatibilize polyolefins and silicone rubbers to form TPEs of the invention, it is likely that such compositions would have been widely used. In fact, as compared to polyamide/silicone rubber or polyester/silicone rubber TPEs, systems for which compatibilization was known, compatibilized polyolefin/silicone rubber TPEs of the invention offer significant cost savings.

The present invention fulfills a long felt need by providing a new TPE that is made from polyolefins and silicone rubbers and a compatibilizing agent for them, where the compatibilizing agent is a polymer comprising both olefin- and silicone-containing moieties, wherein silicone is in the backbone or grafted to the backbone of the polymer. For purposes of this invention, “silicone-containing polymer” means a polymer where silicone is in the backbone of the polymer, a graft copolymer where silicone is grafted to a polyolefin homopolymeric backbone, or a graft copolymer where silicone is grafted to a polyolefin-containing copolymeric backbone.

One preferred embodiment of the invention comprises a TPE comprising a polyolefin, a silicone rubber, and a compatibilizing agent comprising a silicone-containing polymer. Also disclosed is a method for preparing compositions of the invention and a method for improving organic oil resistance of a TPE composition according to the invention.

One advantage of the present invention is the ability to impart useful properties of silicone rubbers to TPE compositions, particularly those with enhanced performance properties. These compositional and performance benefits are obtainable in a TPE system—without requiring use of thermoset processing equipment and the associated drawbacks associated with traditional silicone rubber processing. According to the invention, TPE compositions are able to be prepared at a lower cost than thermoset silicone rubbers and processed using conventional thermoplastic processing equipment, which advantageously enables one to reprocess the material and recycle processing scrap.

Features and advantages of the TPE compositions of the present invention, methods of their preparation and use will become apparent from disclosure of the embodiments and examples of the invention below.

### EMBODIMENTS OF THE INVENTION

Definitions

An “elastomeric composition” is generally a composition that can behave as either a TPE or a thermoset elastomer depending upon the ratio of the hard and soft segments, the ratio of the thermoplastic to the elastomer phase and/or the extent of crosslinking. In addition to behaving as such, the elastomeric composition also retains elastomeric or rubbery properties.

A “thermoplastic elastomer” (TPE) is generally a polymer or blend of polymers that can be processed and recycled in the same way as a conventional thermoplastic material, yet having properties and performance similar to that of an elastomer or rubber at the service temperature at which it is used. Notably, blends (or alloys) of plastic and elastomeric rubber have become increasingly important in the production of TPEs, particularly for the replacement of thermoset rubber or flexible polyvinyl chloride (PVC) in various applications.

A “thermoplastic vulcanizate” (TPV) is a type of TPE, where the elastomer phase is partially or completely crosslinked, vulcanized or cured, such that the TPV can be processed and recycled in the same way as a conventional thermoplastic material, yet retaining properties and performance similar to that of a vulcanized elastomer or rubber at the service temperature at which it is used. TPVs are becoming increasingly important in the production of high performance TPEs, particularly for the replacement of thermoset rubber in various applications. One reason for this trend is the inability of thermoset rubbers to be effectively reprocessed after their formation. This makes certain processing steps which may be desired by the end user, such as hot-melt processing, problematic. Further, thermoplastic materials, as opposed to thermoset materials, are able to be recycled, resulting in considerable reduction in scrap.

For purposes of this invention, “compatible” means that the rubber phase of the TPE has good adhesion to and is finely dispersed in a continuous olefinic phase. “Generally compatible” means that the uncrosslinked or crosslinked rubber phase of the TPE has a good adhesion to the thermoplastic phase, and the dispersed phase is intimately intermixed within the continuous phase. If the rubber is the continuous phase, the dispersed polyolefin particle is smaller than 10 μm in diameter. When the polyolefin is the continuous matrix phase, the average rubber particle size can range from as small as physically possible to about 10 μm in diameter. Desirably, the particle size of the disperse phase particles can range from about 0.1 μm to about 5 μm in diameter, and preferably from about 0.3 μm to about 2 μm in diameter. Typically, the compatibility is investigated using Atomic Force Microscopy (AFM). AFM can elucidate the morphology development of the polyolefin/silicone rubber blends with and without compatibilizer, can develop structure/processing/property relationships of such blends , and can demonstrate the usefulness of AFM as a prediction tool in developing structure/property/processing relationships of such compatibilized blends.

Thus, a “compatibilizer” or “compatibilizing agent” functions to compatibilize the polyolefins and silicone rubbers. A thermoplastic compatibilizer for the silicone rubber phase in a TPE is useful in the present invention because without it, an incompatible material would result where the thermoplastic olefin phase and the elastomeric silicone rubber phase would delaminate and give unpredictable and irreproducible properties. Compatibilizers provide decreased time for dispersion of the rubber as well as a decrease in particle size of the rubber domains, all while maintaining equivalent or better mechanical properties at a lower Shore A hardness.

The term “copolymer” is used to encompass polymers prepared from at least two chemically different monomer units. Thus, the term copolymer encompasses those polymers prepared from two different monomer units, those prepared from three different monomer units (also known as “terpolymers”), et cetera. In this case the copolymer contains both olefinic and silicone moieties.

Thermoplastic Elastomeric Compositions

Thermoplastic elastomer (TPE) compositions of the invention generally comprise at least one thennoplastic and at least one elastomer. In addition, compositions of the invention and processes for their preparation are improved by the addition of a compatibilizer for the thennoplastic and elastomer.

A subset of TPEs of the invention is thermoplastic vulcanizates, where the elastomer is partially or completely crosslinked. In further embodiments, TPEs may also comprise optional processing oils, fillers, colorants, other additives, or combinations thereof.

Thermoplastic

Thermoplastics are generally materials that can be molded or otherwise shaped and reprocessed at temperatures at or higher than their softening or melting point. The present invention is based on thermoplastic polyolefins.

Polyolefins are preferred thermoplastic materials, as they are fundamental building blocks in polymer science and engineering because of their low cost and high-volume production. Non-limiting examples of polyolefins useful as thermoplastic olefins of the invention include homopolymers and copolymers of lower α-olefins such as 1-butene, 1-pentene, 1-hexene, 2-methyl-1-propene, 3-methyl-1-pentene, 4-methyl-1-pentene, styrene, norbomene, 5-methyl-1-hexene, and other unsaturated hydrocarbons as well as ethylene, butylene, and propylene. For example, polyethylene and polypropylene are two such homopolymers.

Polypropylene is most preferred and is now capable of being combined effectively with a silicone rubber elastomer according to the invention. It should be understood that, due to its origin and method of preparation, polypropylene often contains minor amounts of other components such as ethylene-containing units. So long as the polymer is predominantly derived from propylene, it is useful as and deemed to be a polypropylene homopolymer in accordance with the invention and as understood by those of ordinary skill in the art.

Polypropylene has thermoplastic properties best explained by a recitation of the following mechanical and physical properties: a rigid semi-crystalline polymer with a modulus of about 300 MPa to about 1 GPa, a yield stress of about 5 MPa to about 35 MPa, and an elongation to ranging from about 10% to about 1,000%. While tacticity of polypropylene varies, due to its availability and low cost, isotactic polypropylene is preferred for use in the invention. Thus, preferred embodiments of the invention comprise isotactic polypropylene as the major thermoplastic component.

Polypropylene was found to be particularly beneficial when used in accordance with the present invention, partly due to its non-polar nature and relatively low cost. The non-polar nature of polypropylene provides particularly good resistance to polar solvents, including acids, bases, and many industrial chemicals. Thus, compatibilized TPEs prepared therefrom exhibit excellent and desired properties, such as high temperature organic oil resistance and resistance to polar solvents.

While more than one thermoplastic can be used in accordance with the present invention, it is preferred that a single thermoplastic component comprises at least about 90% by weight of the thermoplastic component, more preferably at least about 95% by weight of the thermoplastic component, and most preferably about 100% by weight of the thermoplastic component. When multiple thermoplastic materials are used for the thermoplastic component, optimization of the type and amount of compatibilizer is more difficult, particularly when the chemical nature of the individual thermoplastic materials varies. Ideally and preferably, only one thermoplastic material need be compatibilized with only one silicone rubber elastomer for ease of formulation and processing.

Selection of a polyolefin from commercial producers is often based on Melt Flow Rate (MFR) properties. The MFR can range from about 0.05 to about 1,400 g/10 minutes, and preferably from about 0.5 to about 70 g/10 minutes at 230° C. and under a 2.16 kg load. For polypropylene, that MFR should be from about 0.5 to about 70 g/10 minutes, and preferably from about 1 to about 35 g/10 minutes at 230° C. and under a 2.16 kg load. A number of well known suppliers, including Dow Chemicals, Huntsman Chemicals, Nova Polymers, Solvay, ExxonMobil Chemicals, Basell Polyolefins, and BP Amoco have available polyolefins such as polypropylene that are suitable for use in the invention. Other polyolefins such as high density polyethylene (HDPE), low density polyethylene (LDPE), linear low density polyethylene (LLDPE), olefin plastomers, polybutene-1, etc. can also be used in lieu of or in combination with polypropylene as the thermoplastic phase.

Elastomer

Elastomers are generally materials that can be stretched to at least twice their original length and be retracted very rapidly to approximately their original length when released. The present invention is based on silicone rubber elastomers. ASTM D 1418 describes several suitable classes of silicone rubber.

The use of silicone rubber is desirable because of the variety of useful properties possessed by many silicone rubbers. These properties include their wide useful temperature range (often extending from about −65° C. to about 315° C.), their resistance to hydrocarbon chemicals, their flexibility, their lubricity, their dielectric properties, their water repellency, and their relative inertness to ozone, corona, and other extreme weather environments. Producing TPEs with silicone rubber greatly expands the applicability of the TPEs due to the relative ease of processing and product design flexibility possessed by such compositions.

Any suitable silicone rubber may be used as the elastomer component in TPE compositions of the invention. Those of ordinary skill in the art are readily familiar with a wide variety of silicone rubbers and their properties. Many are based on (di)methyl silicone. Others are based on fluorosilicone. Silicone rubbers based on methyl silicone (MQ) and methyl-vinyl silicone (VMQ) are the most common and exhibit flexibility up to about −55° C. Silicone rubbers based on phenyl-methyl silicone (PMQ) and methyl-phenyl-vinyl silicone (PVMQ) show flexibility all the way up to −100° C.

The silicone rubber may be optionally crosslinked (i.e., cured), either partially or fully. If crosslinked, those of ordinary skill in the art are readily familiar with processes for the same and useful catalysts therefor. For example, silicone rubber may be crosslinked with benzoyl peroxide or other free radical initiators, with or without the use of an additional catalyst or accelerator. If crosslinking of the silicone rubber is desired, it is preferred that the silicone rubber have unsaturation in its side chain. When used, preferably a crosslinker that is specific to the rubber is used, such that integrity of the thermoplastic polyolefin is preserved during vulcanization. For example, organohydrido silicon compounds can be used to cure alkenyl-functional silicone rubbers via a hydrosilation reaction. Other crosslinking methods known to one skilled in the art could also be optionally used instead of benzoyl peroxide in this invention.

For some applications especially where cost is of primary importance, other inexpensive elastomers such as, for example, ethylene-propylene-diene monomer (EPDM) and/or nitrile rubber and/or chloroprene and/or chlorinated polyethylene may optionally be added to the formulation in addition to the silicone elastomer. When non-silicone elastomers are used in this manner, it is preferred that the majority of the elastomer, preferably at least about 80% of the overall elastomer weight, still comprises silicone elastomer. Otherwise, overall compatibility of the formulation may be difficult to optimize. Ideally and preferably, only one silicone rubber elastomer need be compatibilized with only one thermoplastic material for ease of formulation and processing.

The elastomer itself may be provided in a variety of forms. For example, rubbers are available in liquid, powder, bale, shredded, or pelletized form. The form in which the uncured elastomer is provided influences the type of processing equipment and parameters needed. Those of ordinary skill in the art are readily familiar with processing elastomers in these various forms and will make the appropriate selections. For example, when the elastomer is supplied in bale form, a shredder is generally used to break up the elastomer into a shredded form prior to its addition to the processing equipment in which the TPE is prepared.

Those of ordinary skill in the art are readily familiar with processes for preparation of elastomers useful in the present invention. Further, many commercial suppliers are also well known. A number of commercial sources of silicone rubber, for example, are available, including Dow Corning and GE Silicones.

Compatibilizing Agent

In the production of TPEs, for example, it is often desirable and advantageous to include a compatibilizer to promote synergistic integration of the two distinct components—the thermoplastic and elastomer—when attempting to provide certain improved performance properties as compared to those observed with either component alone. Yet, until the present invention, conventional compatibilizers have not provided the desired properties and processing advantages such that they are capable of effectively compatibilizing polyolefins and silicone rubber elastomers.

It is desirable, advantageous, and now known how to include a compatibilizer (i.e., compatibilizing agent) in order to promote synergistic integration of the two distinct components in compositions of the invention—the thermoplastic and elastomer—particularly when attempting to provide certain improved performance properties as compared to those observed with either component alone. Accordingly, at least one compatibilizer is used as a component of compatibilized TPE compositions prepared according to the present invention.

In preferred embodiments, the compatibilizer need not chemically react with either the thermoplastic or the elastomer components of the TPE. Rather, the compatibilizer functions to facilitate physical blending and compatibilization of the TPE composition.

Advantageously, the compatibilizer can diffuse into the elastomer phase of TPE when in a molten state. With subsequent crystallization upon cooling, the compatibilizer links domains of silicone elastomer particles dispersed in a polyolefin matrix or domains of polyolefin particles dispersed in a silicone elastomer matrix depending on the volume ratio of the thermoplastic and silicone elastomer components and their relative viscosities.

For optimum effectiveness, the compatibilizer is a silicone-containing polymer as defined above. For example, the compatibilizer comprises a silicone-grafted olefin-derived polymer or a copolymer containing a polyolefin and a silicone or silane-containing copolymer in the backbone of certain embodiments of the invention. The compatibilizer could also comprise olefin-containing moieties grafted to a silicone-containing polymeric backbone. Such compatibilizers compatibilize the thermoplastic polyolefin phase with the silicone rubber phase of TPE compositions so prepared. The nature of the graft structure (e.g., pendant, terminal, or comb) is not critical, but the physical and chemical nature of the silicone-containing polymeric compatibilizer should be factored when determining the amount of compatibilizer needed in order to obtain desired properties in the resulting composition.

Within those preferred silicone-containing polymers, the silicone-containing moieties preferably comprise about 1 to about 95 percent by weight of the silicone-containing polymer based on total weight of the compatibilizer. Further preferred are silicone-containing polymers that comprise about 1 to about 50 percent by weight, and more preferably about 1 to about 15 percent by weight, silicone-containing moieties based on total weight of the compatibilizer. In addition, the number of silicone-containing moieties and their location within, or location of grafting to, the backbone should be considered when selecting a suitable compatibilizer for the TPE.

The olefin-containing moiety can be thermoplastic or elastomeric in nature, but it is preferably thermoplastic. Preferably, however, the olefin-containing moiety is a polymer comprising a majority of repeat olefin units. For example, the polymer can be a polyolefin or olefin-based elastomer. Particularly preferred compatibilizers are silicone-grafted polyethylene when the thermoplastic comprises polyethylene as the major component and silicone-grafted polypropylene when the thermoplastic comprises polypropylene as the major component. Also useful, yet not as effective at compatibilizing the polyolefin as the corresponding grafted polyolefin-containing copolymers, is silicone-grafted ethylene-propylene-diene rubber (EPDM).

It is not necessary for the silicone-containing polymers to be prepared prior to the addition of the compatibilizer components to the TPE composition, but it is preferred. In other words, silicone-containing polymer compatibilizers can be formed in-situ. Although preparation of suitable silicone-containing polymers is within the knowledge of those skilled in the art, several such silicone-containing polymers are available from commercial suppliers.

Silicone-grafted polypropylene and silicone-grafted polyethylene are available from companies such as Optatech Corporation, which is located in Finland. For example, Optatech has commercialized silicone-grafted polyethylene using the trade designation, Lubotene™ RLF 4009 LD, and silicone-grafted polypropylene using the trade designation, Lubotene™ RLF 13006 LD.

Silicone-grafted EPDM (which may be referred to as silicone-modified EPDM) is commercially available from Uniroyal Chemical division of Crompton Corporation, Middlebury, Conn., under trade designations such as ROYALTHERM, which is provided in many suitable grades (e.g., 1411, 1421, 1711, 1721, and 650P).

Silane-grafted polyolefins are available from PolyOne Corp. under the trade name, Syncure®, from So.F.teR as Forlink®, and from Padanaplast as Sioplas®.

Generally, a minor amount of a silicone-containing polymer compatibilizer of the invention can effectively compatibilize TPEs of the invention. “Minor amount” means a minor weight percentage of compatibilizer, relative to the silicone rubber elastomer. Desirably, the minor weight percentage ranges from about 0.5 to about 10.0, and preferably from about 1 to about 5.0. Expressed alternatively in parts per hundred parts of rubber (“phr”), the minor amount of compatibilizer ranges from about 0.5 to about 50 phr, and preferably, from about 1.0 to about 10 phr, depending on the silicone rubber elastomer selected.

Optional Processing Oil

The use of processing oils to effect oil extension of the elastomer is well known in the art. In the production of TPEs, for example, it is often desirable to include an oil to extend the elastomer portion of the composition. This oil extension provides the properties of lower hardness and better compression set while further reducing cost of the elastomer to achieve the same volume.

Oil can be a separate ingredient in the TPE composition or can be a part of the elastomer component itself, depending on the commercial source of elastomer supply. Concentration of oil in the elastomeric composition will generally range from about 0 to about 300 phr, and preferably from about 0 to about 150 phr, but may vary outside of these ranges as understood by those of ordinary skill in the art.

Non-limiting examples of oils suitable for optional use in the present invention include silicone, aromatic, paraffinic, and naphthenic mineral oils. When silicone rubber is the only elastomer component present in the composition, it is preferred, but not necessary, to utilize silicone oil. When other elastomers are present also, non-silicone oils can be readily used, but their use is not preferred when enhanced organic oil resistance is desired.

Other Optional Additives

Any suitable additive may be included in desired amounts in TPEs of the invention. For example, fillers (e.g., calcined clay, nanoclay, kaolin clay, talc, silicates, and carbonates), pigments and colorants (e.g., carbon black), flame retardants, antioxidants, conductive particles, UV-inhibitors, stabilizers, coupling agents (e.g., silanes, maleated polyolefins, zirconates and titanates), plasticizers, lubricants, antiblocking agents, antistatic agents, waxes, foaming agents, and combinations thereof may be beneficially used in certain applications. Those of ordinary skill in the art will readily understand selection and use of such additives.

Further, it was discovered that the use of nanoclay improved the barrier properties as well as the flammability characteristics of certain compositions of the invention. Thus, the use of nanoclay to improve the barrier properties and flammability characteristics provides more flexibility in formulation and is further desirable according to certain aspects of the invention.

Thermoplastic Elastomers

Each of the above-described components is selected such that the elastomer phase of the TPE has good adhesion to and is finely dispersed in a continuous thermoplastic phase or the thermoplastic phase has good adhesion to and is finely dispersed in a continuous elastomer phase as the case may be. The average particle size can vary, but will typically range from as small as physically possible to about 10 μm in diameter. Desirably, the particle size can range from about 0.1 μm to about 5 μm in diameter, and preferably from about 0.1 μm to about 2 μm in diameter in particularly preferred compatible TPE systems.

The ratio of thermoplastic to elastomer components varies depending on the intended application and the amount of compatibilizer used in the composition. The selection of the specific types and amounts of these components according to the invention can readily be performed by those of ordinary skill in the art.

Preparation of Thermoplastic Elastomeric Compositions

Selection of Components

Preferably, the thermoplastic polyolefin and silicone rubber components of the TPE are compatibilized to the extent that at least one physical property of the TPE (as compared to the TPE without the compatibilizer) is improved. For example, preferred embodiments of the invention provide compositions exhibiting superior organic oil resistance, particularly at high temperatures. Certain preferred embodiments of the invention also provide compositions having lower friction performance, which is particularly beneficial in certain applications.

A suitable amount of the compatibilizer is used to compatibilize the TPE components. The weight ratio of the compatibilizer to the base TPE components (i.e., the thermoplastic polyolefin and the silicone rubber) is generally about 0.1% to about 20% based on parts by weight. When improved organic oil resistance and/or reduced friction performance is desired, preferably the ratio of the compatibilizer to base TPE components is generally about 1% to about 10%, and more preferably about 1% to about 8%, based on parts by weight. It should be understood, however, that these ratios may vary depending on the type of compatibilizer used and the proportion and type of chemical moieties therein.

The type and amount of each of the thermoplastic polyolefin and silicone rubber are selected such that they contribute to achieving desired properties in the compatibilized TPE composition. Accordingly, compatibilized TPE compositions are designed with a view toward their intended application. The ratio of thermoplastic polyolefin to silicone rubber is generally about 5% to about 95% based on parts by weight. When improved oil resistance and/or reduced friction performance is desired, preferably the ratio of thermoplastic polyolefin to silicone rubber is generally about 10% to about 90%, more preferably about 15% to about 85%, based on parts by weight. Typically the continuous phase is phase with the lower viscosity and the larger volume ratio. As the level of crosslinking increases the viscosity of the rubber phase increases and beyond a certain level of crosslinking, the continuous phase is the thermoplastic, while the rubber phase is the dispersed domains.

When at least partial crosslinking of the silicone rubber elastomer phase is desired, an appropriate amount of crosslinking agent (i.e., curative) and/or catalyst (and/or accelerator) can be used to cure the elastomer phase to the desired degree in the desired amount of time. For curing silicone elastomers, peroxide or phenolic curatives can be used as known to those of ordinary skill in the art.

For example, a peroxide curative with an optional co-catalyst (to increase the reaction rate) can be used in an amount suitable to effect the desired cure of the elastomer. In general, the ratio of amount of the curative used in relation to the amount of the uncured elastomer depends on the curing rate desired. A higher proportion of the curative will facilitate faster curing rates. If a peroxide curative is used with a co-catalyst, the amount of peroxide is generally about 0.05% to about 10% by weight based on total weight of the silicone rubber elastomer. The corresponding and combined amounts of peroxide and co-catalyst (or accelerator) are most preferably about 0.1% to about 5%, and most preferably about 0.3% to about 2% by weight based on total weight of the silicone rubber elastomer. The weight ratio of the peroxide to co-catalyst is generally about 1:4 to about 4:1, depending upon the rate of reaction and the residence time needed for the particular process used.

Selection of Processing Equipment and Processing of the TPE Composition

Processing of the composition can occur via batch or continuous processing. Using either batch or continuous processing, components of the composition can be mixed (and optionally heated to react when, for example, at least partially vulcanization of the silicone rubber is desired) in a single piece of equipment or the components can be mixed (and optionally heated to vulcanize the silicone rubber and/or process the composition into the desired shape and size) in multiple pieces of equipment. Economies of scale for production lead to a preference for continuous processing, whereby the compositions can be formed into desired shapes and sizes continuously with their preparation.

In one embodiment of a batch process, the compositions can be prepared by mixing the components in a first piece of equipment. Mechanical mixers, such as Banbury-type, Brabender-type, roll mill, dry turbo mixers and the like are suitable for this purpose.

In one embodiment, all base TPE components (i.e., silicone rubber and thermoplastic polyolefin) of the composition can be charged into the mixer at a temperature ranging from about 170° C. to about 210° C., and preferably from about 175° C. to about 185° C. Mixing proceeds at a pace ranging from about 10 to about 100 rpm (revolutions per minute), and preferably from about 75 to about 85 rpm for a duration ranging from about 1 to about 5 minutes, and preferably from about 2 to about 4 minutes.

Although earlier addition is possible, thereafter a suitable amount of the compatibilizer is added or components for the same are added for formation in-situ. The compatibilizer is then formed in-situ, if necessary, and the compatibilizer is mixed with the base TPE components. Optional additives are added during the process as appropriate and according to the knowledge of those skilled in the art.

It should be noted that compounding time is shortened significantly when using a twin- or single-screw extruder or a co-kneading extruder. The resulting TPE composition is then transferred to other equipment for formation into the desired shape and size. For example, plugs of the compatibilized TPE composition can be removed from the mixer and compression-molded into, for example, a 7.6×15.2×0.31 cm (3×6×0.125 inch) plaque mold at a temperature ranging from about 170° C. to about 210° C., and preferably from about 175 to about 185° C. The plug material can be held under no pressure for 30 seconds, after which pressure can be increased to 1,100 KN force over a period of about 3 minutes. After application of pressure of 1,100 KN force for 4 minutes, the samples can be cooled to ambient temperature while pressure is maintained.

During continuous processing, the base TPE components (i.e., the silicone rubber and thermoplastic polyolefin) can be first mixed in a suitable mixer without substantial application of heat. Mechanical mixers, such as Banbury-type, Brabender-type, roll mill, dry turbo mixers and the like are suitable for this purpose. In this embodiment, the mixed components are then conveyed continuously to another piece of equipment.

Optionally, in this further piece of equipment, the mixture can be heated to at least partially vulcanize the silicone rubber within the TPE when desired. Reactive extrusion equipment is suitable for this purpose. Reactive extrusion enables dynamic vulcanization to occur, which is preferable when preparing TPVs. Dynamic vulcanization can advantageously reduce processing time and throughput. However, methods other than dynamic vulcanization can be utilized to prepare TPV compositions of the invention where the silicone rubber is at least partially vulcanized. For example, the silicone rubber can be vulcanized in the absence of the thennoplastic polyolefin, powdered, and mixed with the thennoplastic polyolefin at a temperature above the melting or softening point of the thermoplastic polyolefin to form a TPE or a TPV.

A wide variety of reactive extrusion equipment can be employed for processing the mixture. Preferred is a twin screw co-rotating extruder with a length-to-diameter (L/D) ratio ranging from about 24 to about 84, and preferably from about 32 to about 64. Utilization of relatively low L/D ratio (e.g., 44 or less) extruders is possible, advantageously, with certain preferred embodiments of the invention.

To achieve vulcanization of the silicone rubber within the composition, the mixture is typically heated to a temperature substantially equal to or greater then the softening point of any thermoplastic employed and for a sufficient time to obtain a composition of the desired homogeneity and crosslinking of the silicone rubber. For example, the extrusion profile for a preferred PP/silicone rubber TPE composition can be a flat 190° C. profile and 300 rpm The components can be fed into the reaction extruder at 27 kg/hr (60 lb/hr) using, for example, a 25-mm twin screw extruder. Lower rates may be used, for example, where the residence time needs to be higher in order to complete the degree of vulcanization desired. The actual rate and residence times needed are dependent upon the total amount of silicone rubber, the type of silicone rubber, the type and amount of curative if used, as well as the L/D of the extruder and the precise screw design and configuration.

The components of the composition may be added to the processing equipment in any suitable amount and in any suitable order. Preferably, however, elastomer and thermoplastic components are generally added to the processing equipment prior to addition of the compatibilizer. For example, the thermoplastic polyolefin is preferably mixed with the silicone rubber and processing oil prior to addition of the compatibilizer. If used, a suitable amount of suitable processing oil (e.g., silicone oil and the like) is preferably added to the silicone rubber prior to addition of the thermoplastic polyolefin.

The compatibilizer and other additives are generally added after addition of the foregoing components. The compatibilizer is preferably added to the composition prior to addition of other additives, including any additives used to effect vulcanization of the silicone rubber desired. If the compatibilizer is a silicone-containing polymer, the components thereof can be added to the mixture and grafted in-situ. When using additives for vulcanization, those components may be added, preheated and injected, directly into a melt stream of the previously added components or into the main hopper where the components reside in a premixed state. The same applies for formation of the compatibilizer in-situ.

Usefulness of the Invention

Compositions of the invention exhibit beneficial performance properties, such as resistance to oil—even at relatively high temperatures. This can be observed in the reduced oil absorption of these blends as well as higher retention of mechanical properties in the presence of hydrocarbon oil at 1 00° C., 125° C. or at 140° C., compared to those based on comparable PP-EPDM compositions. In addition, as compared to TPEs in general, the compositions of the invention have significant advantages due to the silicone rubber employed therein. These advantages include their resistance to hydrocarbon chemicals, their flexibility, their lubricity, their dielectric properties, their water repellency, and their relative inertness to ozone, corona, and other extreme weather environments. Producing TPEs with silicone rubber greatly expands the applicability of the TPEs due to the relative ease of processing (i.e., requiring no more than conventional thermoplastic processing equipment and generating scrap and material that can be recycled) and product design flexibility possessed by such compositions.

Further embodiments of the invention are described in the following non-limiting Examples.

### EXAMPLES

General Experimental Materials Examples

Unless noted otherwise, the materials identified in Table 1 were used as indicated in the examples described below.

TABLE 1

| Trade | | |
|---|---|---|
| Designation or | | |
| Abbreviation | Description | Source |
| Calcium | Calcium carbonate | Fisher Scientific Company; Fair |
| Carbonate | | Lawn, NJ |
| HDPE | High-density polyethylene with a | Several sources |
| | melt index of 12-20 | |
| Irganox ™ B-225 | 1:1 mixture of phenolic antioxidant | Ciba Specialty Chemicals North |
| | and phosphite | America, Tarrytown, NY |
| | | (www.cibasc.com) |
| Lubotene ™ RLF | Silicone-grafted polyethylene | Optatech Corporation, Finland |
| 4009 LD | | |
| Lubotene ™ RLF | Silicone-grafted polypropylene | Optatech Corporation, Finland |
| 13006 LD | | |
| Pro-fax ™ 6331 | Polypropylene homopolymer with a | Basell North America Inc., Elkton, |
| NW | MFR of 12.0 g/10 min at 230° C. | MD (www.basell.com) |
| | under a 2.16 kg load | |
| Dow Corning | Silicone Oil (350 Centistokes) | Dow Corning |
| 200 Silicone Oil | | (www.dowcorning.com) |
| Fluid | | |
| SE6035 General | Silicone Rubber | General Electric (www.ge.com) |
| Purpose Silplus ® | | |
| Elastomer | | |

### Examples 1-8 and Comparative Examples 1 and 2

For each of these examples, the materials listed in Table 2 were combined in a Brabender mixing bowl, with all materials except the silicone rubber and the silicone oil added first. The molten material was fluxed and then the silicone rubber was added, and once it was fluxed into a homogenous melt, the silicone rubber was added slowly in two or three batches to ensure that it was absorbed well and did not leak outside the mixing bowl.

TABLE 2

| | Parts by Weight (%) | | | | | | | | | |
|---|---|---|---|---|---|---|---|---|---|---|
| | | | | | Comp. | | | | | Comp. |
| Material | Ex. 1 | Ex. 2 | Ex. 3 | Ex. 4 | Ex. 1 | Ex. 5 | Ex. 6 | Ex. 7 | Ex. 8 | Ex. 2 |
| Calcium Carbonate | 4.75 | 4.75 | 4.75 | 4.75 | 4.75 | 4.75 | 4.75 | 4.75 | 4.75 | 4.75 |
| HDPE | — | — | — | — | — | 20 | 10 | 30 | 40 | 30 |
| Irganox ™ B-225 | 0.25 | 0.25 | 0.25 | 0.25 | 0.25 | 0.25 | 0.25 | 0.25 | 0.25 | 0.25 |
| Lubotene ™ RLF 4009 LD | — | — | — | — | — | 5 | 5 | 5 | 5 | — |
| Lubotene ™ RLF 13006 LD | 5 | 5 | 5 | 5 | — | — | — | — | — | — |
| Pro-fax ™ 6331 NW | 20 | 10 | 30 | 40 | 30 | — | — | — | — | |
| Silicone Oil | 20 | 15 | 10 | 5 | 10 | 20 | 15 | 10 | 5 | 10 |
| Silicone Rubber | 50 | 65 | 50 | 45 | 55 | 50 | 65 | 50 | 45 | 55 |

After each composition was prepared, the properties were measured after compression molding some plaques and die-cutting the test specimen out of the plaques. Various performance data and physical measurements were taken along with Atomic Force Microscopy which showed that the compatibilized compositions of this invention in Examples 1 to 4 exhibited much smaller distribution of the polypropylene in the silicone rubber matrix compared to Comparative Example 1. Similarly, the compatibilized compositions of this invention in Examples 5 to 8 showed much smaller distribution of the high density polyethylene in the silicone rubber matrix compared to Comparative Example 2.

The invention is not limited to the above embodiments. The claims follow.

What is claimed is:

1. A thermoplastic elastomer composition comprising:
at least one thermoplastic polyolefin,
at least one silicone rubber elastomer, and
at least one compatibilizing agent comprising a silicone-containing polymer.

2. The thermoplastic elastomer composition of claim 1, wherein the silicone-containing polymer is selected from the group consisting of (a) a polymer where silicone is in the backbone of the polymer, (b) a graft copolymer where silicone is grafted to a polyolefin homopolymeric backbone, and (3) a graft copolymer where silicone is grafted to a polyolefin-containing copolymeric backbone.

3. The thermoplastic elastomer composition of claim 2, wherein the polyolefin is selected from the group consisting of polyethylene, polypropylene, and EPDM.

4. The thermoplastic elastomer composition of claim 1, wherein base thermoplastic elastomer components consist of one thermoplastic and at least one elastomer component.

5. The thermoplastic elastomer composition of claim 1, further comprising a nanoclay additive.

6. The thermoplastic elastomer composition of claim 1, further comprising silicone oil.

7. The thermoplastic elastomer composition of claim 1, wherein the compatibilizer comprises about 1 to about 10 percent by weight based on combined weight of the at least one thermoplastic polyolefin and the at least one silicone rubber elastomer.

8. The thermoplastic elastomer composition of claim 1, wherein the ratio of the at least one thermoplastic polyolefin to silicone rubber is about 15% to about 85% by weight.

9. A method of preparing the thermoplastic elastomer composition of claim 1, the method comprising:
mixing the at least one thermoplastic polyolefin with the at least one silicone rubber elastomer;
mixing the at least one compatibilizer with the at least one thermoplastic polyolefin and the at least one silicone rubber elastomer in an amount sufficient to compatibilize the thermoplastic elastomer composition; and
optionally at least partially vulcanizing the at least one silicone rubber elastomer.

10. The method of claim 9, wherein the compatibilizer is formed in-situ.
